(19) United States
(12) Patent Application Publication
(10) Pub. No.: US 2015/0120257 A1
(43) Pub. Date: Apr. 30, 2015

(54) METHOD OF OPERATING OSCILLATOR INCLUDING VERIFICATION OF OPERATION OF THE OSCILLATOR

(71) Applicant: SAMSUNG ELECTRONICS CO., LTD., Suwon-si (KR)

(72) Inventors: Jae-Jin PARK, Seongnam-si (KR); Jae-Ha KIM, Seoul (KR); Tae-Hwan KIM, Seoul (KR); Ji-Hwan HYUN, Daegu (KR)

(73) Assignee: SNU R & DB FOUNDATION, Seoul (KR)

(21) Appl. No.: 14/447,149

(22) Filed: Jul. 30, 2014

(30) Foreign Application Priority Data
Oct. 31, 2013 (KR) 10-2013-0131703

(51) Int. Cl. G06F 17/50

(52) U.S. Cl. CPC G06F 17/5009
USPC 703/2; 703/13

(57) ABSTRACT

A method of verifying operation of an oscillator includes performing a Monte-Carlo simulation with respect to points in an initial-conditions space, and then judging whether a frequency error exists. An oscillation error is determined to exist when the frequency error exists. Additional operations include determining a point at which a probability of having a settling time longer than a maximum value, of a settling time obtained up to a present time, is maximum when the frequency error does not exist. The Monte-Carlo simulation is then performed on the determined point to judge whether the frequency error exists.

### CROSS-REFERENCE TO RELATED APPLICATION

Korean Patent Application No. 10-2013-0131703, filed on Oct. 31, 2013, and entitled, “Method of Operating Oscillator including Verification of Operation of the Oscillator,” is incorporated by reference herein in its entirety.

### BACKGROUND

1. Field

One or more embodiments described herein relate to an oscillator.

2. Description of Related Art

An oscillator generates a pulse signal at a desired frequency for use in electronic devices. The oscillator may oscillate at a frequency different from the desired frequency due to a circuit layout, a process deviation, or change of a temperature and/or a voltage.

### SUMMARY

In accordance with one embodiment, a method of verifying operation of an oscillator includes performing a Monte-Carlo simulation with respect to points in an initial-conditions space; judging whether a frequency error exists; determining that an oscillation error exists when the frequency error exists; determining a point at which a probability of having a settling time longer than a maximum value, of a settling time obtained up to a present time, is maximum when the frequency error does not exist; and performing the Monte-Carlo simulation on the determined point to judge whether the frequency error exists.

The method may include determining existence of an operation error of the oscillator using the Monte-Carlo simulation. The point may be determined based on a predictive global optimization algorithm. The predictive global optimization algorithm may obtain an initial condition that generates an operation error of the oscillator using a settling time as an objective function.

The method may include judging whether the maximum probability is lower than a specified reliability level; determining that an oscillation error does not exist when the maximum probability is lower than the specified reliability level; and performing the Monte-Carlo simulation on the determined point when the maximum probability is higher than the specified reliability level.

The method may include using a plurality of probes for measuring initial conditions. Determining the point may include calculating a probability distribution of a settling time with respect to an entire space of initial-conditions using interpolation. The interpolation may include radial-basis function (RBF) interpolation.

The settling time may increase as a position nears a boundary of two regions of convergence, which may be obtained by changing initial conditions of one or more nodes of the oscillator. When one operation mode is found, another operation mode may be found by following a direction in which the settling time is increasing.

In accordance with another embodiment, a method of operating of an oscillator includes searching an initial-conditions space and detecting an oscillation error based on a frequency and a settling time; determining an initial condition in which an oscillation error is generated when the oscillation error is generated; and excluding the initial condition in which the oscillation error is generated to operate the oscillator.

Detecting the oscillation error may include performing a Monte-Carlo simulation with respect to points in an initial-conditions space; judging whether a frequency error exists; determining that an oscillation error exists when the frequency error exists; determining a point at which a probability of having a settling time longer than a maximum value, of a settling time obtained up to a present time, is maximum when the frequency error does not exist; judging whether the maximum probability is lower than a specified reliability level; determining that an oscillation error does not exist when the maximum probability is lower than the specified reliability level; and performing the Monte-Carlo simulation on the determined point to judge whether the frequency error exists when the maximum probability is higher than the specified reliability level.

Determining the point may include calculating a probability distribution of a settling time with respect to an entire space of initial-conditions using interpolation. The interpolation may include radial-basis function (RBF) interpolation.

Detecting an oscillation error may include performing a Monte-Carlo simulation with respect to points in the initial-conditions space; judging whether a frequency error exists; determining that an oscillation error exists when the frequency error exists; determining a point at which a probability of having a settling time longer than a maximum value, of a settling time obtained up to a present time, is maximum when the frequency error does not exist; and performing the Monte-Carlo simulation on the determined point to judge whether the frequency error exists.

In accordance with another embodiment, a method of verifying operation of an oscillator includes performing a first simulation for points in an initial-conditions space; judging whether a frequency error exists; determining that an oscillation error exists when the frequency error exists; determining a point at which a probability of having a settling time longer than a predetermined value reaches a certain level when the frequency error does not exist; and performing a second simulation on the determined point to judge whether the frequency error exists.

The predetermined value may be a maximum value of a settling time obtained up to a present time. The certain level may be a maximum. The first simulation may be a Monte-Carlo simulation. The second simulation may be a Monte-Carlo simulation.

### BRIEF DESCRIPTION OF THE DRAWINGS

Features will become apparent to those of skill in the art by describing in detail exemplary embodiments with reference to the attached drawings in which:

FIG. 1 illustrates a one type of 3-stage coupled ring oscillator;

FIG. 2 illustrates settling times according to initial conditions of nodes in the ring oscillator of FIG. 1;

FIG. 3 illustrates an embodiment of a method for operating an oscillator,

FIG. 4 illustrates an embodiment of a method for detecting oscillation error;

FIG. 5 illustrates another embodiment of a method for detecting oscillation error;

FIG. 6 illustrates another embodiment of a method for detecting oscillation error;

FIG. 7 illustrates one type of 2-stage differential ring oscillator;

FIG. 8 illustrates an operation trace for initial conditions of nodes in the differential ring oscillator of FIG. 7;

FIGS. 9 and 10 illustrate distributions of settling times for initial conditions of nodes in the differential ring oscillator of FIG. 7 and a region of oscillation error, and

FIGS. 11 and 12 illustrate examples of results achieved by one or more of the aforementioned method embodiments for detecting oscillation error compared with the differential ring oscillator of FIG. 7.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

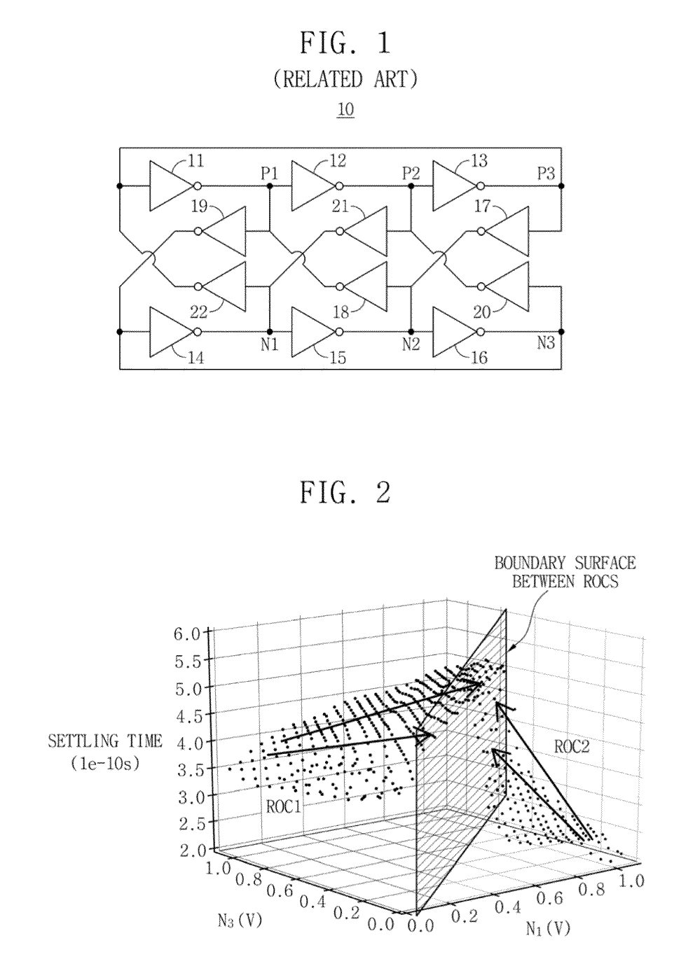

FIG. 1 illustrates one type of 3-stage coupled ring oscillator 10 which has been proposed. Referring to FIG. 1, ring oscillator 10 includes inverters 11 to 16 in a primary path and inverters 17 to 22 in an auxiliary path. The sizes of transistors for inverters 11 to 16 may be different from the transistors for inverters 17 to 22. For example, the size of transistor 11 may be larger than transistor 17. The ring oscillator 10 may also include nodes P1 to P3 and N1 to N3 at which voltages are measured. Ring oscillator 10 may have a single operation mode or multiple operation modes based on the sizes of the transistors used.

FIG. 2 illustrates a distribution of settling times for initial conditions of nodes in the ring oscillator of FIG. 1. The distribution of measured settling times is shown for the case of when four nodes among six nodes are fixed and initial conditions of nodes N1 and N3 are varied.

Referring to FIG. 2, the settling times become longer as points are nearer to a boundary surface in both the first region of convergence ROC1 and the second region of convergence ROC2. Therefore, when one operation mode is found, another operation mode may be found when following a direction in which the settling time is increasing. For example, the settling time may serve as a guide to finding out the existence of other operation modes.

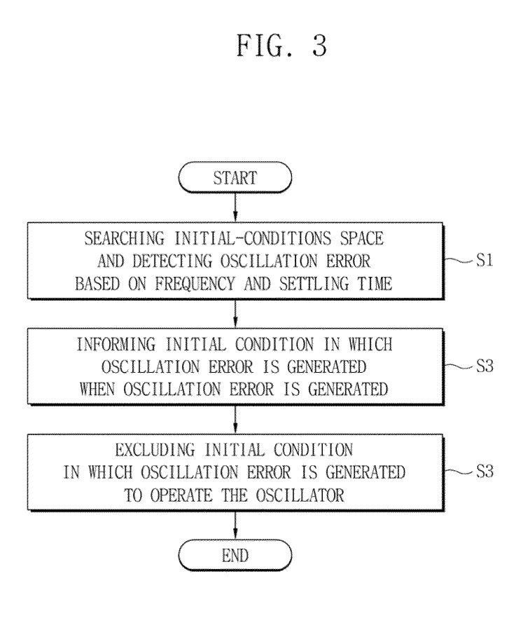

FIG. 3 illustrates an embodiment of a method for operating an oscillator. This method includes the following operations:

1) searching an initial-conditions space and detecting an oscillation error based on a frequency and a settling time (S1);

2) informing an initial condition in which an oscillation error is generated when the oscillation error is generated (S2); and

3) excluding the initial condition in which the oscillation error is generated to operate the oscillator (S3).

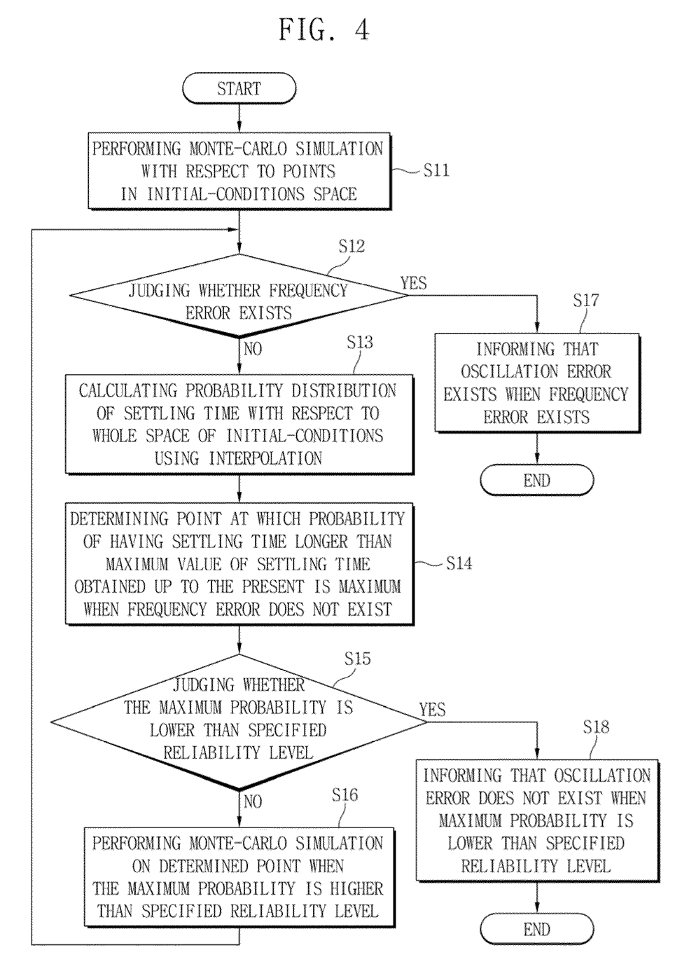

FIG. 4 illustrates an embodiment of a method for detecting oscillation error for the operating method of FIG. 3. Referring to FIG. 4, the method for detecting oscillation error includes the following operations:

1) performing a Monte-Carlo simulation with respect to points in an initial-conditions space (S11);

2) judging whether a frequency error exists (S12);

3) informing that an oscillation error exists when frequency error exists (S17);

4) calculating a probability distribution of a settling time with respect to a whole space of initial-conditions using interpolation (S13);

5) determining a point at which the probability of having a settling time longer than a maximum value of a settling time obtained up to the present is maximum when the frequency error does not exist (S14);

6) judging whether the maximum probability is lower than a specified reliability level (S15);

7) informing that an oscillation error does not exist when the maximum probability is lower than the specified reliability level (S18); and

8) performing the Monte-Carlo simulation on the determined point to judge whether the frequency error exists when the maximum probability is higher than the specified reliability level (S16);

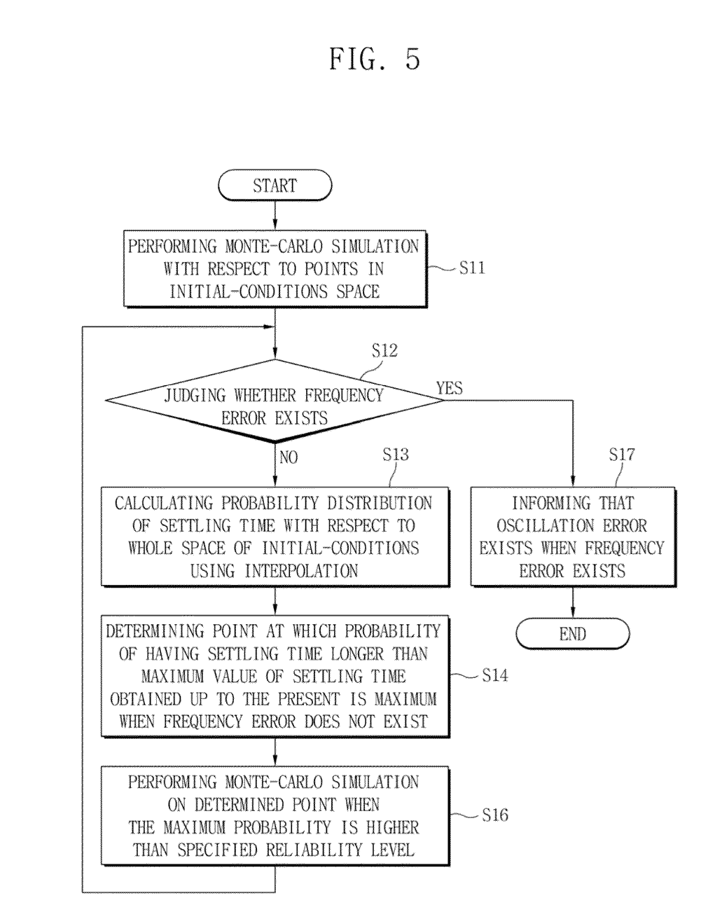

FIG. 5 illustrates another embodiment of a method for detecting oscillation error for the operating method of FIG. 3. Referring to FIG. 5, this method embodiment includes the following operations:

1) performing a Monte-Carlo simulation with respect to points in an initial-conditions space (S11);

2) judging whether a frequency error exists (S12);

3) informing that an oscillation error exists when frequency error exists (S17);

4) calculating a probability distribution of a settling time with respect to a whole space of initial-conditions using interpolation (S13);

5) determining a point at which the probability of having a settling time longer than a maximum value of a settling time obtained up to the present is maximum when the frequency error does not exist (S14); and

6) performing the Monte-Carlo simulation on the determined point to judge whether the frequency error exists (S16);

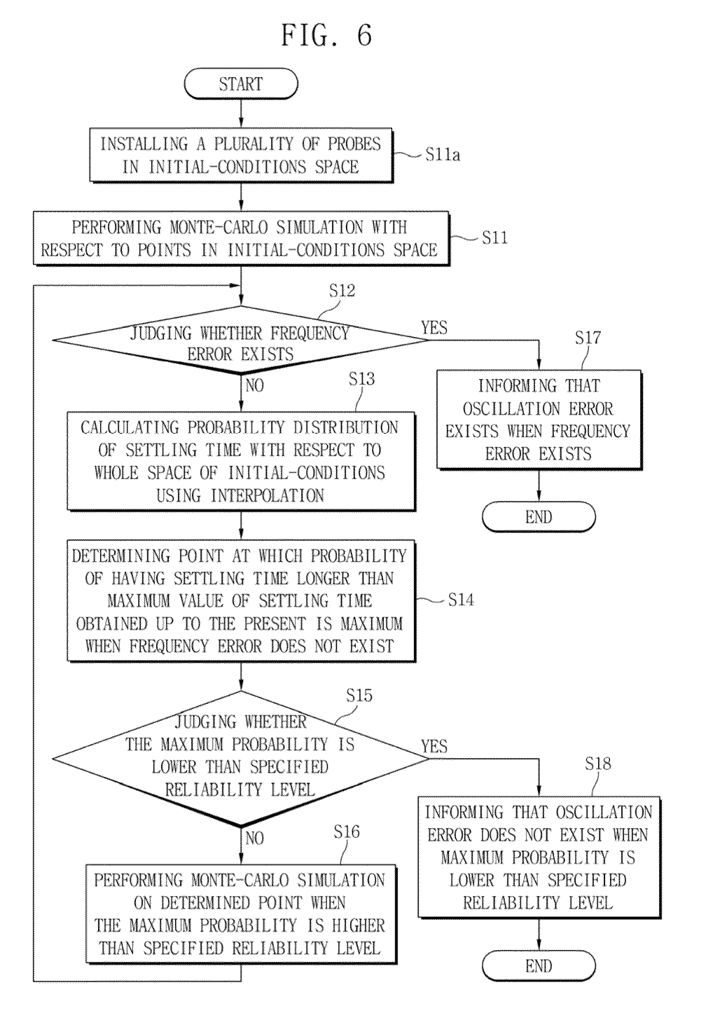

FIG. 6 illustrates another embodiment of a method for detecting oscillation error in the operating method of FIG. 3. Referring to FIG. 6, this method embodiment includes the following operations:

1) installing a plurality of probes in an initial-conditions space (S11a);

2) performing a Monte-Carlo simulation with respect to points in the initial-conditions space (S11);

3) judging whether a frequency error exists (S12);

4) informing that an oscillation error exists when frequency error exists (S17);

5) calculating a probability distribution of a settling time with respect to a whole space of initial-conditions using interpolation (S13);

6) determining a point at which the probability of having a settling time longer than a maximum value of a settling time obtained up to the present is maximum when the frequency error does not exist (S14);

7) judging whether the maximum probability is lower than a specified reliability level (S15).

8) informing that an oscillation error does not exist when the maximum probability is lower than the specified reliability level (S18); and

9) performing the Monte-Carlo simulation on the determined point to judge whether the frequency error exists when the maximum probability is higher than the specified reliability level (S16);

Hereinafter, a method of verifying an operation of an oscillator for obtaining an initial condition in which an operation error of the oscillator is generated and a method of operating the oscillator will now be described referring to FIGS. 1 to 6.

Because the one or more of the aforementioned embodiments are oriented to obtain a specific initial condition in which operation fail is generated, two measuring values may be defined for the method of verifying operation of an oscillator. One is frequency error and the other is settling time. As the characteristic value defining operation of the oscillator is frequency, the standard for judging normal operation of the oscillator may be frequency.

When a known initial state in a normal operation is x₀_{ₙₒₘᵢₙₐₗ}, and an arbitrary initial state is \vec{x₀}, frequency error (ε) of an oscillator may be represented as Equation 1.

$$ɛ ( {\vec{x}}_{0} ) {=}^{Δ} {max}_{i} \vert \frac{{f}_{i} ( {\vec{x}}_{0} )}{{f}_{i} ( {\vec{x}}_{{0}_{nominal}} )} - 1 \vert = 0 \qquad ( 1 )$$

When Equation 1 has a value other than 0, it may be determined that the oscillator has an oscillation error.

When no frequency error exists, Equation 1 may uniformly have a value of 0 in the arbitrary initial state. Therefore, Equation 1 may not provide information about which region of an initial-conditions space should be searched, in order to find out the region in which the oscillator is malfunctioning.

The settling time may represent a time from a starting point of a certain initial state to a point at which the oscillator converges to a final oscillation mode. The settling time increases for point positions farther away from a normal operation trace. When there are multiple oscillation modes, the settling time may have infinitesimal value at the boundary surface of the initial conditions of the oscillation modes. Therefore, when the distribution of settling times in the initial-conditions space is known, it may be determined that the oscillator operates in an operation mode other than a desired operation mode.

Referring again to FIG. 2, it is noted that settling times increase as points are nearer to a boundary surface in both first region of convergence ROC1 and second region of convergence ROC2. Therefore, when one operation mode is found, another operation mode may be found by following the direction in which the settling time is increasing.

The method of verifying operation of an oscillator according to one embodiment may actually search a problem region (e.g., a region in which oscillation error exists) using the two measuring values defined above, i.e., frequency error and settling time, and a predictive global optimization algorithm.

The initial-conditions space is divided uniformly and discontinuously, and a search is performed on points of the initial-conditions space. In the beginning, when a few points are selected and the settling times at the points are obtained, the settling times at other points may be approximately estimated using, for example, a radial-basis function (RBF) interpolation. The settling time at one point may have a probability distribution, rather than a specific value as a result of process dispersion.

When the distribution is a normal distribution, the probability distribution for the whole area of the initial-conditions space may be estimated based on an average and a standard deviation of the settling time obtained by simulation using the interpolation. The probability distribution for an arbitrary region of the initial-conditions space may be also estimated, because the normal distribution may be defined using the average and the standard deviation.

Based on the probability distribution obtained above, a point at which the probability of having a settling time longer than a maximum value of a settling time, obtained by simulation up to the present is maximum, may be determined and the simulation may be performed on the point. The fact that the frequency error at the newly-added point is not 0 means that frequency error is generated, which provides an indication that oscillation error exists and the algorithm is ended.

When the frequency error at the newly-added point is 0, the pattern of the probability distribution for the whole area of the initial-conditions space may be changed by performing additional interpolation using newly-added simulation information. After performing this process repeatedly, and when the region in which the oscillation error is generated is not found until the probability of having the longer settling time decreases to a certain value, it is determined that there is no possibility of oscillation error existing and the algorithm ends.

When a probability distribution of at an arbitrary point in the initial-conditions space is t(\vec{x₀}), and a settling time at a point which has the longest settling time among the whole simulated points is tₘₐₓ, the expectation function in which settling times are longer than the settling time may be represented by Equation 2.

f(\vec{x₀})=E[max{0,(t(\vec{x₀})−tₘₐₓ)}] (2)

The point at which the value of Equation 2 has a maximum is determined, and simulation is performed at this point.

When the frequency error of the newly-added point is not 0, the algorithm ends because a problem exists. When the frequency error at the newly-added point is 0, the pattern of the probability distribution for the whole area of the initial-conditions space may be changed by performing additional interpolation based on newly-added simulation information.

After performing this process repeatedly, and when the region in which the oscillation error is generated is not found until the probability of having the longer settling time decreases to a certain value, the algorithm ends and it is concluded that there is no possibility that the oscillation error exists, for a reliability level that corresponds to a threshold probability which is the standard of termination.

While searching the initial-conditions space as described above, one or more of the aforementioned the method embodiments may perform a more effective search. This is because these embodiments preferentially search for points at which the probability of existence outside of a normal region which is presently searched is large.

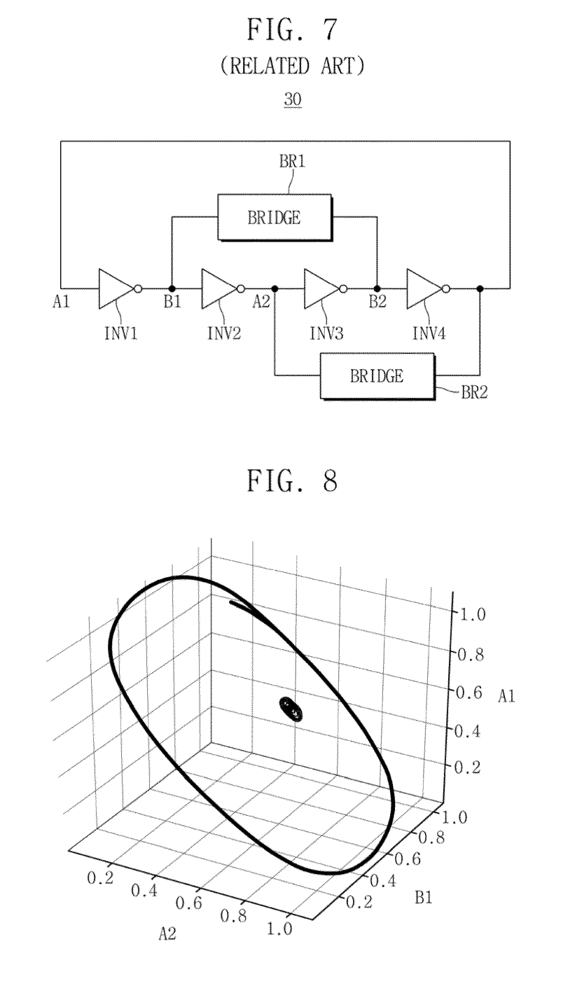

FIG. 7 illustrates one type of 2-stage differential ring oscillator 30. Referring to FIG. 2, differential ring oscillator 30 includes inverters INV1 to INV4 connected in cascaded form, a first bridge BR1 connected in parallel to the inverters INV2 and INV3, and a second bridge BR2 connected in parallel to the inverters INV3 and INV4. The differential ring oscillator 30 may include nodes A1, B1, A2, B2 at which voltages are measured. The first bridge BR1 and the second bridge BR2 may include inverters. The sizes of transistors used for the inverters in the first bridge BR1 and second bridge BR2 may be different from the sizes of transistors used for inverters INV1 to INV4.

FIG. 8 illustrates an operation trace according to initial conditions of nodes in the differential ring oscillator of FIG. 7. In FIG. 8, operation traces for two modes obtained according to relative sizes of transistors used for the inverters included in a main path and transistors used for the inverters in the bridges BR1 and BR2 are shown.

A voltage of node B2 is fixed, and operation traces according to voltage changes of nodes A1, B1 and A2 are shown. According to relative sizes of the transistors in the main path and bridges BR1 and BR2, differential ring oscillator 30 of FIG. 7 may perform a normal oscillation or may be fixed to a DC value and may not oscillate (e.g., DC equilibrium).

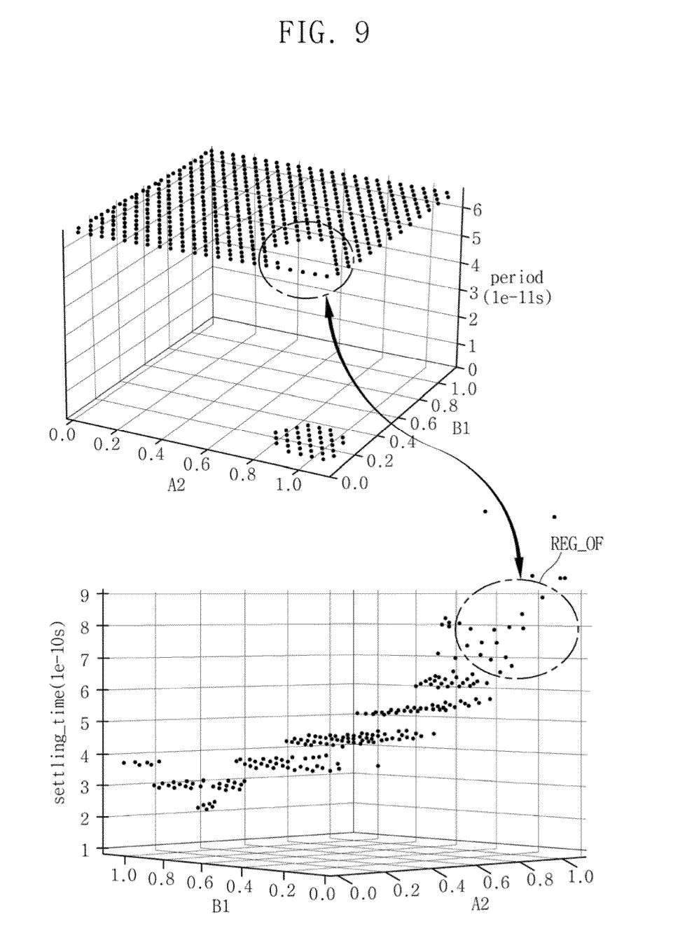

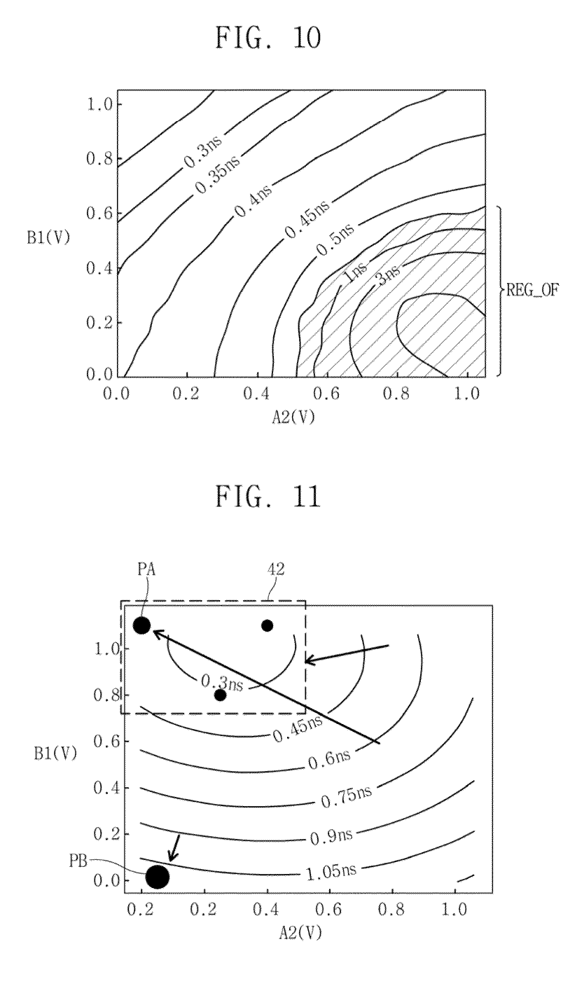

FIGS. 9 and 10 illustrate settling times according to initial conditions of nodes in the differential ring oscillator of FIG. 7 and a region of oscillation error. FIGS. 9 and 10 illustrate the distribution of settling times when voltages of two nodes A2 and B1 among four nodes in the differential ring oscillator 30 of FIG. 7 are varied. Referring to FIGS. 9 and 10, the settling time varies according to voltages of nodes A2 and B1, and has a very large value and a region REG_OF of oscillation error exists near a point (A2=VDD and B1=GND).

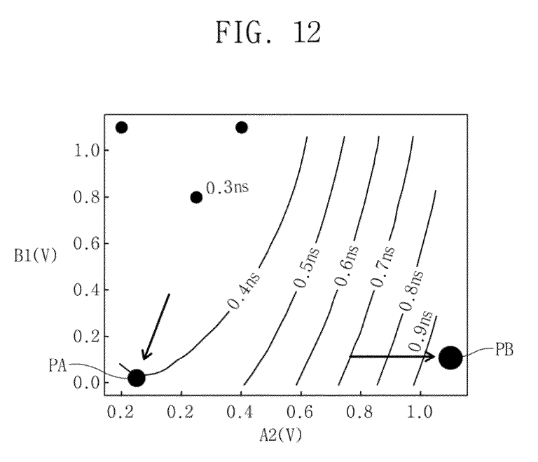

FIGS. 11 and 12 illustrate an example of results obtained by applying one or more of the aforementioned method embodiments for detecting oscillation error. These results are compared to results of the differential ring oscillator of FIG. 7.

FIG. 11 illustrates the distribution of settling times obtained by arranging initial probes at a left upper region 42 and performing interpolation on the simulation result at points at which initial probes are arranged. The simulation result shows that the point that has the longest settling time is PA, among the three initial probes. It may be noted that the point at which the probability of having a longest settling time is maximum is PB using this distribution of settling time. Data may be obtained through additional simulation at this point.

FIG. 12 illustrates the distribution of settling time newly-obtained using the data obtained through the additional simulation at PB. Referring to FIG. 12, the distribution of contour lines varies similarly to the distribution of actual settling time. Further, it may be noted that, in FIG. 12, settling time of PA among the initial probes in FIG. 11 becomes longer when one or more of the method embodiments are applied. Based on the new distribution of settling time, the obtained point at which the probability of having a longest settling time is maximum is PB in FIG. 12. The point PB is inside of region REG_OF of oscillation error in FIG. 10. When the fact that a frequency error is larger than 0 is verified through simulation at point PB, the fact that the region of oscillation error (which is a problem region) exists is informed and the algorithm ends.

By way of summation and review, in accordance with one or more of the aforementioned embodiments, a method is provided for verifying operation of an oscillator capable of obtaining an initial condition in which an operation error of the oscillator is generated. The operation may be operated excluding the initial condition that generated the operation error. One or more additional embodiments provide a method of operating of an oscillator including the method of verifying operation of the oscillator.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A method of verifying operation of an oscillator, the method comprising:
performing a Monte-Carlo simulation with respect to points in an initial-conditions space;
judging whether a frequency error exists;
determining that an oscillation error exists when the frequency error exists;
determining a point at which a probability of having a settling time longer than a maximum value, of a settling time obtained up to a present time, is maximum when the frequency error does not exist; and
performing the Monte-Carlo simulation on the determined point to judge whether the frequency error exists.

2. The method as claimed in claim 1, further comprising:
determining existence of an operation error of the oscillator using the Monte-Carlo simulation.

3. The method as claimed in claim 1, wherein the point is determined based on a predictive global optimization algorithm.

4. The method as claimed in claim 1, wherein the predictive global optimization algorithm is to obtain an initial condition that generates an operation error of the oscillator using a settling time as an objective function.

5. The method as claimed in claim 1, further comprising:
judging whether the maximum probability is lower than a specified reliability level;
determining that an oscillation error does not exist when the maximum probability is lower than the specified reliability level; and
performing the Monte-Carlo simulation on the determined point when the maximum probability is higher than the specified reliability level.

6. The method as claimed in claim 5, further comprising:
using a plurality of probes for measuring initial conditions.

7. The method as claimed in claim 5, wherein determining the point includes calculating a probability distribution of a settling time with respect to an entire space of initial-conditions using interpolation.

8. The method as claimed in claim 7, wherein the interpolation includes radial-basis function (RBF) interpolation.

9. The method as claimed in claim 5, wherein the settling time increases as a position nears a boundary of two regions of convergence, which is obtained by changing initial conditions of one or more nodes of the oscillator.

10. The method as claimed in claim 5, wherein, when one operation mode is found, another operation mode is to be found by following a direction in which the settling time is increasing.

11. A method of operating of an oscillator, the method comprising:
searching an initial-conditions space and detecting an oscillation error based on a frequency and a settling time;
determining an initial condition in which an oscillation error is generated when the oscillation error is generated; and
excluding the initial condition in which the oscillation error is generated to operate the oscillator.

12. The method as claimed in claim 11, wherein detecting the oscillation error includes:
performing a Monte-Carlo simulation with respect to points in an initial-conditions space;
judging whether a frequency error exists;
determining that an oscillation error exists when the frequency error exists;
determining a point at which a probability of having a settling time longer than a maximum value, of a settling time obtained up to a present time, is maximum when the frequency error does not exist;
judging whether the maximum probability is lower than a specified reliability level;
determining that an oscillation error does not exist when the maximum probability is lower than the specified reliability level; and
performing the Monte-Carlo simulation on the determined point to judge whether the frequency error exists when the maximum probability is higher than the specified reliability level.

13. The method as claimed in claim 12, wherein determining the point includes calculating a probability distribution of a settling time with respect to an entire space of initial-conditions using interpolation.

14. The method as claimed in claim 13, wherein the interpolation includes radial-basis function (RBF) interpolation.

15. The method as claimed in claim 11, wherein detecting an oscillation error includes:
performing a Monte-Carlo simulation with respect to points in the initial-conditions space;
judging whether a frequency error exists;
determining that an oscillation error exists when the frequency error exists;
determining a point at which a probability of having a settling time longer than a maximum value, of a settling time obtained up to a present time, is maximum when the frequency error does not exist; and
performing the Monte-Carlo simulation on the determined point to judge whether the frequency error exists.

16. A method of verifying operation of an oscillator, the method comprising:
performing a first simulation for points in an initial-conditions space;
judging whether a frequency error exists;
determining that an oscillation error exists when the frequency error exists;
determining a point at which a probability of having a settling time longer than a predetermined value reaches a certain level when the frequency error does not exist; and
performing a second simulation on the determined point to judge whether the frequency error exists.

17. The method as claimed in claim 16, wherein the predetermined value is a maximum value of a settling time obtained up to a present time.

18. The method as claimed in claim 16, wherein the certain level is a maximum.

19. The method as claimed in claim 16, wherein the first simulation is a Monte-Carlo simulation.

20. The method as claimed in claim 19, wherein the second simulation is a Monte-Carlo simulation.
